(19) United States
(12) Patent Application Publication
(10) Pub. No.: US 2010/0121744 A1
(43) Pub. Date: May 13, 2010

(54) USAGE DATA MONITORING AND COMMUNICATION BETWEEN MULTIPLE DEVICES

(75) Inventors: Steven Belz, Cedar Park, TX (US); James Pratt, Round Rock, TX (US); Marc Sullivan, Austin, TX (US)

Correspondence Address: AT&T Legal Department - T&W;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/267,297

(22) Filed: Nov. 7, 2008

(51) Int. Cl. G06Q 10/00; G06F 15/16; G06F 7/06; G06F 17/30

(52) U.S. Cl. 705/30; 709/224; 707/E17.014

(57) ABSTRACT

A system and method for by which real-time monitoring and communication of usage data is conducted between a set of N numbered of devices where N is and integer. According to an embodiment, a communication network provides a common core architecture in which the devices connected to the system are converged regardless of their access network requirements or functional capacity. The system has the capacity to monitor and analyze all the usage information of each device connected to the system in regards to content, identity, type, quality, quantity, time, status, activity level, and metadata associated with the functions and applications utilized on a device. The analysis is further based on information governing a subscriber's devices, preferences, and features held in a subscriber database integrated within the system. The analyzed usage data is further processed through a variety of applications in order to generate a response, such as; a report, an alarm, or tailored options for interacting with the generating device which is deliverable in any format within the capacity of the receiving device including all multimedia aspects and non-multimedia aspects. The system further communicates the response in real-time to any device within the set as designated by the subscriber. In another aspect of the invention, the analyzed usage data can be stored for on demand requests of a communication response from past analysis.

### TECHNICAL FIELD

This invention is related to communication systems. More specifically, this invention relates to a system for monitoring device specific usage information for a set of devices and communicating the usage information to devices within the set.

### BACKGROUND OF THE INVENTION

Advancements in technology have led to reliance and utilization of multiple electronic computing and communicating devices. For example, it is not uncommon for a consumer to have multiple personal computers (PCs) both stationary and portable, landline telephones, interactive televisions (TVs), as well as multiple mobile devices such as cellular phones, personal data assistants (PDAs), and other embedded computing devices. Further, applications available to less sophisticated mobile devices have become increasingly comparable to full-service computing machines. For example, the most recent advanced mobile devices can be associated with word processing software, web browsing software electronic mail software, accounting software and various other types of software. In general applications heretofore only available by way of computing devices and/or Internet Protocol (IP) based network devices are now available on mobile devices utilizing a telecommunications network.

Consumers often utilize multiple mobile and stationary devices with overlapping applications. Several devices are often used concurrently for related purposes. Additionally, many households or environment exist in which multiple people use a set of shared or interconnected devices. As a result, usage information is generated that is applicable and useful amongst the multiple devices and users. For example, a search log conducted on a home PC may be desired to be retrieved by another user on his/her PDA. Additionally, many consumer purchase cellular plans in which multiple services and related charges encompass all of the devices. However, respective users of phones within the plan have no way of learning about specific usage and related charges being generated per device until they receive a monthly billing analysis.

Given advancement in offering capability among multiple devices utilized by consumers, many of such devices have overlapping applications. Furthermore, several of the devices are often used concurrently. Additionally, many environments exist in which multiple people use several shared or interconnected devices. As a result, usage information is generated for each device that is applicable and useful amongst the multiple devices and the multiple users. Additionally, many consumers purchase cellular or telecommunication plans in which the services and related charges encompass multiple devices registered under the single plan. Often the devices under the plan are operated by a multiple users, such as for example a family cellular plan in which several children operate phones under their parents plan. However, as noted above, respective users of the devices within the plan are unable to glean specific usage and charge information per device in real-time.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

A system and method for monitoring device specific usage information for a set of multiple devices and communicating the usage information to the devices within the set in real-time. The system is based on a communication network that provides a common core network having access-agnostic architecture for converged networks. According to an embodiment of the system, an Internet Protocol Multimedia Subsystem (IMS) network provides the common core platform for uniting multiple devices. Within the system, a heterogeneity of wireline and wireless devices such as plain old telephone service (POTs) telephones, interactive TVs, PCs, cellular phones, PDAs, etc. are connected to the common network through all types of access networks.

The system monitors usage information of each device a subscriber has connected to the system. A subscriber may designate one or more devices as a set in which the usage information monitored for each device in the set may be delivered. The system further relies upon a database holding subscriber information related to the devices, monitoring polices, and service plans governing device usage. The system is designed to receive a usage signal from a device and analyze the usage information in regards to content, identity, type, quality, quantity, time, status, activity level, and metadata associated with the functions and applications utilized on a device. The analysis is governed by the monitoring policies outlined in the database.

The system further process the analyzed usage data through a variety of applications in order to generate a response to the usage data, such as; a report, an alarm, or tailored options for interacting with the generating device. The system further communicates the response in real-time to any device within the set as designated by the subscriber. In another aspect of the invention, the analyzed usage data can be stored for on demand requests of a communication response from past analysis. Further, the system supports delivery of a communicated response in any format within the capacity of the receiving device including all multimedia aspects and non-multimedia aspects.

To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a communication system in which different devices connect to their unique network through their access technology specific “cloud.”

FIG. 2 illustrates a communication system in which multiple devices and their reciprocal access technologies are converged through an IMS Network.

FIG. 3 illustrates an exemplary multi-device usage data monitoring and communicating system architecture.

FIG. 4 illustrates a block diagram of an exemplary system for a multi-device usage data monitoring and communicating system.

FIG. 5A presents a methodology by which real-time multi-device usage data monitoring and communicating is established.

FIG. 5B presents a methodology by which multi-device usage data monitoring and communicating is established.

FIG. 6 presents a methodology by which two devices utilizing different access networks communicate usage information in real-time.

FIG. 7A illustrates two devices communicating usage data in real-time.

FIG. 7B illustrates the display of usage information in the receiving device.

FIG. 8A illustrates two device utilizing different access networks communicating usage data in real-time.

FIG. 8B illustrates the display of the usage information in the receiving device.

FIG. 9A illustrates an embodiment of the monitoring system core.

FIG. 9B illustrates another embodiment of the monitoring system core.

FIG. 10 presents a methodology by which real-time multi-device usage data monitoring and communicating is conducted within the monitoring system core.

FIG. 11 illustrates an embodiment of the monitoring policy execution component.

FIG. 12 illustrates another embodiment of the monitoring policy execution component.

FIG. 13 illustrates yet another embodiment of the monitoring policy execution component.

FIG. 14 presents a methodology by which device usage data is processed through the monitoring policy execution component in real-time.

FIG. 15 illustrates an embodiment of the device management component.

FIG. 16. Illustrates an embodiment of the application component.

FIG. 17 presents a methodology by which a usage data signal is processed prior to analysis within the monitoring policy execution component.

FIG. 18 presents a methodology by which a usage data signal is processed following analysis within the monitoring policy execution unit.

FIG. 19 illustrates an example of a device, a mobile handset that, can process multimedia content in accordance with the embodiments disclosed herein.

FIG. 20 illustrates a block diagram of a computer operable to execute the disclosed multi-device usage monitoring and communicating system architecture.

### DETAILED DESCRIPTION OF THE INVENTION

The invention is now described with reference to the drawings, wherein like reference numerals are used to refer to like elements throughout. In the following description, for purposes of explanation, numerous specific details are set forth in order to provide a thorough understanding of the subject invention. It may be evident, however, that the invention can be practiced without these specific details. In other instances, well-known structures and devices are shown in block diagram form in order to facilitate describing the invention.

As used in this application, the terms “component,” “module,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

As used herein, the terms to “infer” or “inference” refer generally to the process of reasoning about or inferring states of the system, environment, and/or user from a set of observations as captured through events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Furthermore, the various embodiments may be implemented as a method, apparatus, or article of manufacture using standard programming and/or engineering techniques to produce software, firmware, hardware, or any combination thereof to control a computer to implement the disclosed embodiments. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the subject disclosure. Moreover, the word “exemplary” is used herein to mean serving as an example, instance, or illustration. Any aspect or design described herein as “exemplary” is not necessarily to be construed as preferred or advantageous over other aspects or designs.

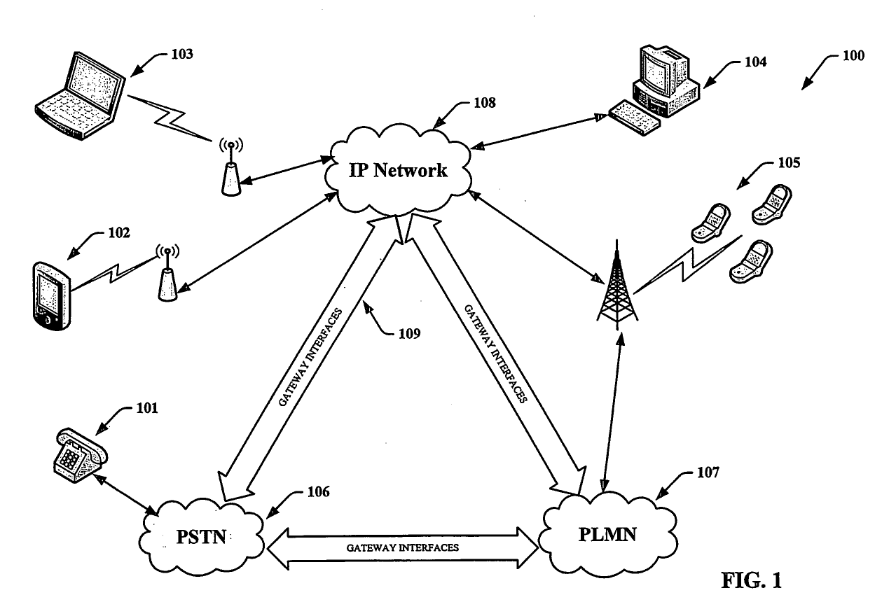

Referring to the drawings, FIG. 1 illustrates a communication system 100 in which different devices connect to their unique network through their access technology specific “cloud.” The different devices include: a landline POTS telephone 101, a PDA 102, a WiFi laptop 103, a PC 104, and a group of cellular telephones 105. It should be appreciated that additional computing devices and access technologies suitable for use in a compliance with the claimed invention may exist or arise, all of which should be considered represented within the general scope of FIG. 1. The access clouds encompass the following access networks: a wireline network or PSTN (Public Switched Telephone Network) 106, a wireless network or PLMN (Public Land Mobile Network) 107, and an IP (Internet Protocol) network 108. Each of the clouds contains separate subscriber and service information for each device. The communication system of FIG. 1 has no common repository to manage this information across all of the networks. Therefore the networks are largely independent of each other in many aspects.

Gateway interfaces 109 enable communications between the networks by providing signaling and data networking. Wired and wireless IP based devices obtain functionality by acting as intelligent endpoints, effectively providing all required functionality with external servers and acting as simple endpoints connecting to specialized servers within the network. Cellular telephones and POTS landlines invariably depend heavily on the PLMN and PSTN infrastructure for their functionality. This creates a problem for consumer's who owns many different kinds of devices.

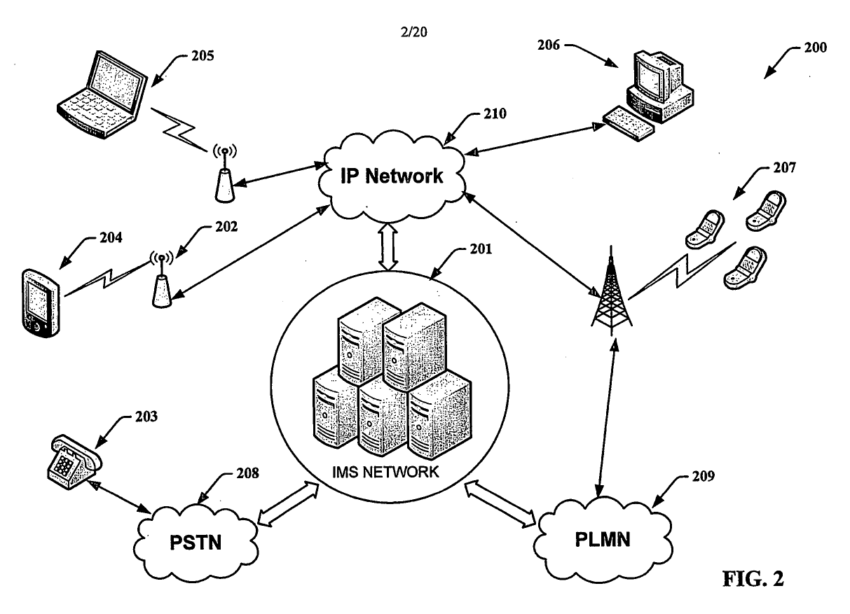

FIG. 2 depicts a communication system 200 in which multiple devices and their reciprocal access technologies are converged through an IMS Network 201. The devices communicate with their associated access network either directly or by way of a wireless access point 202. The different devices include but are not limited to: a landline POTS telephone 203, a PDA 204, a WiFi laptop 205, a PC 206, and a group of cellular telephones 207. The access clouds encompass but are not limited to the following access networks: any wireline network or PSTN (Public Switched Telephone Network) 208, any wireless network or PLMN (Public Land Mobile Network) 209, and any IP (Internet Protocol) network 210. The IMS Network 201 provides common application management across multiple device access networks.

The IP Multimedia Subsystem (IMS) has emerged as a standardized way to offer IP based services that are enabled by one common core and all types of access networks and devices. This IP based core provides a unified application experience across all IP enabled devices, as well as providing service mediation and subscriber profile management. Given the capacity of IMS infrastructure, a heterogeneity of devices can be unified in a manner that allows for the consumer to experience consistency across all of the devices.

Multiple device management exists for both fixed system management and mobile device management. However, these management systems primarily serve the function of monitoring quality performance and maintenance of device operation as opposed to content based data. Although content specific analysis of device usage can be accumulated by existing monitoring or surveillance systems, the information is stored and regulated by a centralized operated. Thus the usage data is not immediately transferable from one device to another in real-time. In addition, existing monitoring systems do not employ one monitoring system for a variety of devices utilizing different access networks. In other words, existing management systems do not allow for convergence of usage information between a heterogeneity of devices and access networks. Thus a need has developed to be able to access machine specific usage information amongst multiple devices in real-time, freeing the consumer from multiple device dependencies for retrieving usage information.

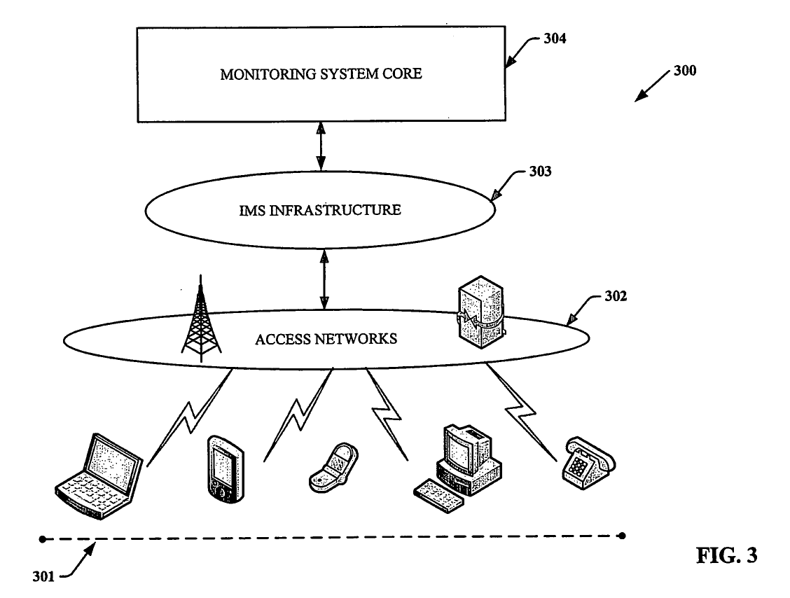

Referring again to the drawings, FIG. 3 illustrates the architecture of a multi-device usage data monitoring and communication system 300 according to an embodiment of the subject invention. The architecture of the subject system compromises one or more devices 301, a variety of access networks 302, an underlying IMS infrastructure 303, and a monitoring system core 304.

The devices 302 may include any suitable device capable of communicating in at least one format or using at least one protocol that is recognized by the monitoring system core. It is not necessary for each device to have an IMS client within for interaction with the IMS network. The devices may be IP enabled. Additionally, the devices may utilize circuit switched networks. For example, the device may be a PDA, WiFi Laptop, cellular phone, landline phone, interactive TV, PC, or PC based VoIP (Voice Over Internet Protocol) phone. Furthermore, it is not necessary for all of the devices employing the subjective system to have the capacity to generate and receive communication of usage data. Certain devices may be enabled to only generate usage data while others only to receive and vice versa. For example, a landline phone may be enabled to receive a signal to transmit an alarming ring until picked up when receiving a usage data communication response from a specific device. However, the device generating the usage data communication response may only possess the capabilities for signaling usage information. For instance, a medical device such as a pacemaker or glucose monitor may be enabled with IP capacity to signal another mobile device when its status has changed. It should be appreciated that additional communicating and computing devices and their reciprocal access technologies may arise, all of which should be considered compatible additions within the architecture of subject communication system so long as they meet the minimum requirements described above.

Referring back to FIG. 3, due to the fact that the IMS infrastructure is access agnostic, a wide variety of access networks are encompassed by the subject system. Thus, in an exemplary embodiment of the invention, a variety of access networks 302 are employed including but not limited to: any PSTN or PLMN networks, any IP based network or more specifically, GSM/GPRS, UMTS, UTRAN, GERAN, CMDA2000, 1Xevdo, HSDPA, WiFi, WiMax, xDSL etc. One with ordinary skill in the art can infer that advancements in network technology will employ new access capabilities, each of which should be considered compatible with the architecture of the subject system. Furthermore, although an IMS architecture is disclosed as the common unifying network for the subjective system, it should be appreciated that advancement in technology may employ additional networks capable of facilitating the subjective system. For instance, any network that is access agnostic and has standard network signaling and transport protocol for a variety of devices with varying computing, communicating, and multimedia capabilities will suffice a proper environment for the subjective system.

In regards to the underlying IMS infrastructure 303 disclosed herein, the signaling used within IMS network is Session Initiation Protocol (SIP). SIP is a signaling and control protocol responsible for creating, modifying, and terminating sessions with one or more devices. Core SIP functionality is defined by the Internet Engineering Task Force (IETF). IMS defines the standard SIP interface between the monitoring system core components and the underlying IMS infrastructure. It should be appreciated that additional signaling protocol may arise which may be replace or be used in conjunction with or SIP. Thus the subject invention is not limited to SIP alone.

The IMS infrastructure 303 comprises of all suitable elements, systems, or servers in the IMS network adapted to serve a call. For example the IMS infrastructure may compromise but is not limited to (not shown): a Call Session Control Function (S-CSCF), a proxy-CSCF (P-CSCF), an interrogate-CSCF (I-CSCF), an application server, (AS), Breakout Control Function (BGCF), a Media Gateway Control Function (MGCF), a Media Gateway (MGW) etc., and any additional IMS service and control elements. The interaction between the BGCF, MGCF, and MGW, allows for the control and signaling functions between sessions which leave the IMS domain, such as PLMN and PSTN signaling.

Regarding the monitoring system core 304, in an exemplary embodiment of the invention, the core 304 contains a variety of unique components organized in a manner for employing the multi-device usage data monitoring and communicating aspects of the subject system. The monitoring system core 304 will later be described in greater detail with reference to its sub-components.

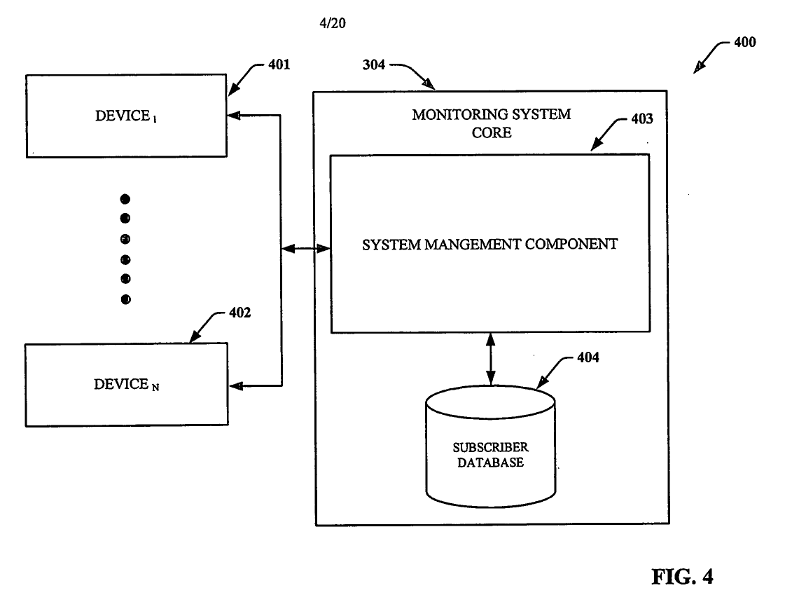

Referring back to the drawings, FIG. 4 presents a high level illustration of an exemplary system 400 for monitoring multi-device usage information and communicating the usage information to one or more devices. The system includes a set of N numbered devices 401-402 joined by a common network, where N is an integer. The common network joining all of the devices is any network that is access agnostic and has standard network signaling and transport protocol for a variety of devices with varying computing, communicating, and multimedia capabilities. In one aspect of the subject system the common network in an IMS network. The devices included in the set 401-402 may include any device as described in reference to FIG. 3. More specifically, the set 401-402 includes any device capable of communicating in at least one format or using at least one protocol that is recognized by the monitoring system core 304.

The monitoring system core comprises a subscriber database SD 404 and a system management component SMC 403. The SD is a centralized control and management point that controls a subscriber's devices, preferences, and features. In other words, the SD holds the instructions governing all of the devices in the set 401-402. Furthermore, the SD can store information for multiple subscribers.

In one embodiment, the SD 404 includes subscriber instructions recording of the devices the subscriber has included in a set and their reciprocal functionalities and capabilities. For example, a subscriber may have included a landline telephone with sound and voice mail capabilities and a PC with a wide range of multimedia capabilities. Additionally, the SD contains subscriber specific information related to device usage monitoring instructions detailing the specific usage information monitoring policies as well as instructions detailing all usage data communication protocol pertaining to each device within the set. In other words, the SD describes what device(s) to monitor, when to monitor that device(s), what type of data analysis is desired or what type of usage should be monitored, and what communication response is desired for each device and or type of usage date associated with the usage data monitored. For each usage data signal the system 400 may generate multiple monitoring policies or entail all the analysis to be conducted for that usage signal within one policy.

For example, a monitoring policy can indicate all calls made from device 1, and 2 between 1:00 am and 6:00 am signal an alarm on phone 3. Or for instance, each time device 5, a PC, accesses web video content, device 6, a PDA, is notified of the content accessed. In another example wherein devices 2 and 3 are phones, the subscriber may elect to have a usage data communication response reporting the minutes used and associated charges sent to device 1 when calls are made from cellular devices 2 and 3. However, more specifically, the subscriber can elect to receive an alarm on device 1 when either device 2 or 3 dial emergency 911 or any other specified number. Additionally, the SD can include instructions pertaining to the hierarchy order in which communication responses are to be sent to the device(s) in the set.

In another aspect of the subject system 400, the SD can contain subscriber information regarding subscriber instructions outlining device service plan agreement parameters and associated billing information. For example, registration within the system can be governed be a service plan where the service provider designates plan parameters and the associated billing information encompassing the entire device monitoring network service. In addition to the service agreement encompassing the network service, the SD can contain information regarding additional service plan agreements associated with the devices within the set of registered devices. For example, many wireless telephone service plans provide various plan parameter options for minute's available, text messaging capacity, long distance, etc. Additionally, the plan parameters include associated charging rates for staying within the plan parameters and rates for usage outside the parameters. Therefore the SD contains all the information regarding all specific service plans associated with the subscriber's devices. In summary, the SD contains unified information for multiple devices in a set of devices joined by a common network while allowing access to the information by each device set.

Referring back to FIG. 4, the system management component 403 is the main component of the system enabling the monitoring and communicating of multiple device usage information. The system management component is adapted to monitor device usage information according to the subscriber instructions held in the subscriber information database. The system management component further assigns the monitoring policy or polices comprising the specific type and degree of usage analysis to be applied to a specific device usage signal. Within the system management component, the device usage information is analyzed, processed, and communicated to one or more of the devices within a set of devices joined by a common network. Additionally the device usage information can be stored for later access and analysis. In this manner, an analysis of the trends and summaries of aggregated device usage information can be made available to multiple devices.

Referring back to FIG. 4, the system 400 is enabled with the capacity to monitor and report all device usage information related to a variety of devices with varying capabilities and functionalities. Therefore the information monitored can be device specific and/or usage specific. Likewise the specific usage monitoring that the system will provide for a particular usage signal is generated in the form of a new monitoring policy for each usage signal processed within the system. The monitoring policy assigned to each usage signal is developed by distilling the monitoring parameters for a specific device as instructed by the SD. In another aspect of the invention, the system 400 is enabled to process usage data at any point of generation. Thus the desired time frame or time frame associated with each device and/or a specific type of usage data can be designated within the SD. For example, the usage data pertaining to a cellular conversation may be desired to be reported to another device at the initial time of call and/or following the completion of the call.

The usage information that can be monitored by the 400 system includes the content, identity, type, quality, quantity, time, status, activity level, and metadata associated with search query data, email log data, instant messaging data, web page visiting data, call log data, multimedia download data, media library data, voice messaging data, text messaging data, software and file download data, caller ID library modification data.

The system 400 is configured to facilitate the interpretation and playing or presentation of usage data in a variety of multimedia forms such as text, audio, still images, graphics, video, multimedia, and the like. In another aspect, communicated usage data can invoke a non-multimedia response such as a vibration. Additional receiving devise responses can be invoked in response to communicated usage data in any manner available within the capacity of the receiving device so long as the receiving device is programmed to respond in that manner. The analyzed and applied usage data that is communicated to a receiving device will herein be referred to as a communication response. Thus a communication response can encompass all forms of usage data communication formats including multimedia formats and non-multimedia formats

According to one embodiment of the subject invention, in regards to cellular or landline phones, the system 400 can extrapolate the identity of parties called, the duration of the call and the associated cost according to the subscriber's cellular plan and produce a usage data analysis that can be communicated to another device(s). In another example, the system can extrapolate a search query conducted on a PC and conduct an analysis of the search information and communicate the usage data to another device(s). Additionally, a communication response can be established instantaneously and communicated in an appropriate format to any of the selected devices included in a set of joined devices 401-402. Furthermore, in addition to viewing, hearing, feeling (in the form of a vibration), etc, the receiving device can be enabled to exploit the usage information in the same functional manner as the originating device. For example, device 2 a PDA can receive a general web page search query conducted on a PC joined in a set. In addition to viewing the search query, the PDA can further interact with websites listed on the query, as if the search had been conducted originally on the PDA.

In another aspect of the subject invention the communication response delivered to a receiving device can allow for the receiving device to interact with the originating device. For example, upon receiving a usage data communication response, the receiving device can elect to send a message to the originating device or any of the other devices in the set. Further, the message can be encoded to control the functionality of the receiving device. For example, the message can turn a device on or off or prevent/enable specific device usage capabilities such as media download capabilities or access to specific websites, etc. In another example, a device can respond to a usage data communication response by invoking a camera on another device(s), have a video of still image produced, and then communicate the video or still image to any of the devices in the joined set.

Additionally and within the interactivity realm, a receiving device can respond to a usage data communication response and elect to interact with the originating device prior to the completion of the originating device(s) specific use. For example, device 1 a cell phone, may desire to listen in on a conversation conducted on device 2, another cell phone, at the beginning of the conversation. In another manner, device 3, a PC, can desire to view the content of a specific webcast accessed on device 4 a PDA, at the initial time of access.

In another embodiment, the system 400 can process metadata associated with a variety of multimedia accessed by a particular device. For example, in addition to communication music downloads made from one device, the system can include an analysis of the attributes associated with the music download such as the artist name, album name, track title, etc., and include this information in the instantaneous report. Furthermore, the metadata associated with device usage as well as any additional content associated with device usage can be made accessible to a device joined with the set of devices connected to the common network which is capable of sending advertisements, coupons, or the like. Therefore in addition to communicating usage data, the system can communicate data related to the usage data of any device joined in a set.

In yet another embodiment, one or more of the devices can contain a locating component such as a GPS system. In turn, the system has the capacity to send an on demand communication response for denoting the location of any of the GPS enabled devices within a set. Similarly, the location of a device can be communicated in real-time when a device within the set has changed locations and subscriber has instructed the changed location to generate an “out of bounds,” or “alarming” communication response.

The examples of the subject system 400 usage data monitoring and communicating capabilities discussed do not represent all of the possible ways in which usage data can be monitored and communicated within the system. In other words, it should be appreciate to one skilled in the art that additional device usage data monitoring and communicating within the scope of the subject system is available.

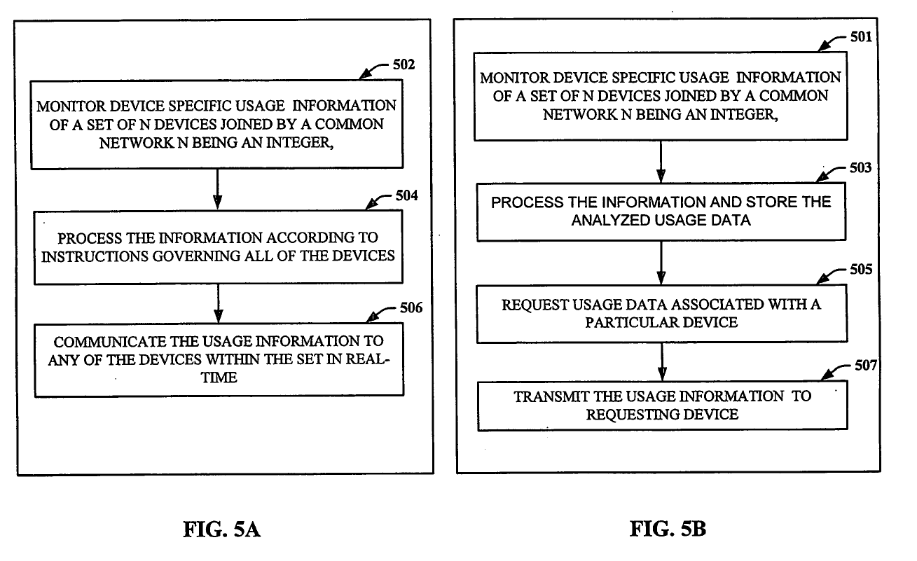

Throughout the descriptions of FIGS. 5-18, the “system” referenced encompasses the system 400 of FIG. 4 for monitoring multi-device usage information and communicating the usage information to one or more devices in a set. Furthermore, reference to a “set” of devices throughout FIGS. 5-18 encompasses all devices a subscriber has registered to the system under a monitoring plan and joined be a common network. A set can include one or more devices.

FIGS. 5A and 5B present a high level methodology by which a multi-device usage data monitoring and communication is established. In FIG. 5A the usage data is communicated to a receiving device in real-time while in FIG. 5B, the usage information is retrieved from a storage component. With respect to FIG. 5A, the method begins at 502, where the system monitors the usage information of a specific device. The device is further part of a set of devices joined by a common network. The set devices can be any number of devices including a set of one. At 504, the usage information is processed according to the monitoring instructions held in the SD 404 which governs all of the devices in a set. At 506, the usage data information is communicated to any of the devices in the set in real-time.

With reference to FIG. 5B, the method begins at 501 where the system monitors the usage information of a specific device. The device is further part of a set of devices joined by a common network. The set of devices can be any number of devices including a set of one. At 503 the usage information is processed and stored in a usage data storage component. At 505, any device within the set then requests usage data associated with a monitored device. At 507, the requested usage information is then transmitted to the requesting device.

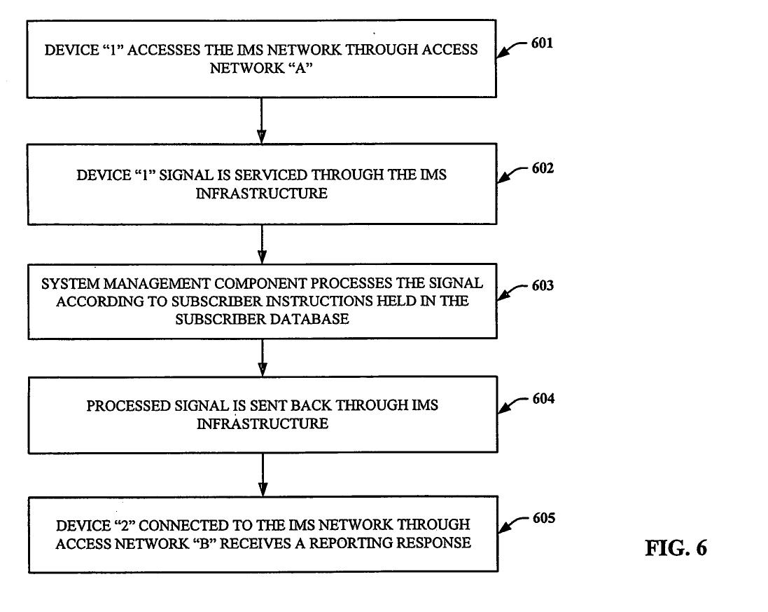

Referring back to the drawings, FIG. 6 presents a methodology by which two devices utilizing different access networks communicate usage information in real-time according to the subject invention wherein the two devices are joined by an IMS network. At 601, a device 1 access the IMS network through it access network A. Device 1 can be a landline telephone and access network A can be a PSTN network. At 602, the usage data signal generated by device 1 is then serviced through an IMS infrastructure. At 603, the system management component process the signal according to subscriber instructions held in the SD. At 604 the processed signal is sent back through the IMS infrastructure. Finally, at 605 device 2, which is also connected to the IMS network through access network B, receives a communication response. Device 2 can be a wireless phone and access network B can be a PLMN network.

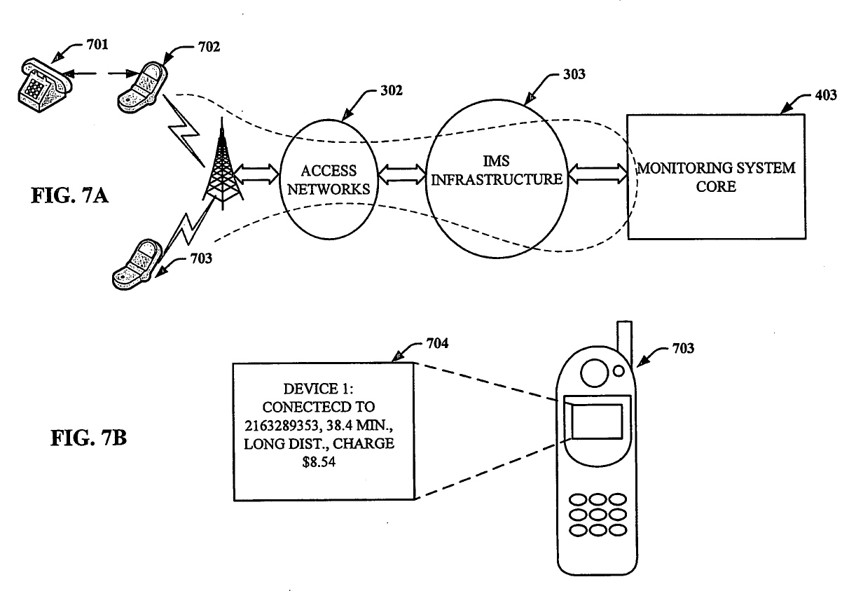

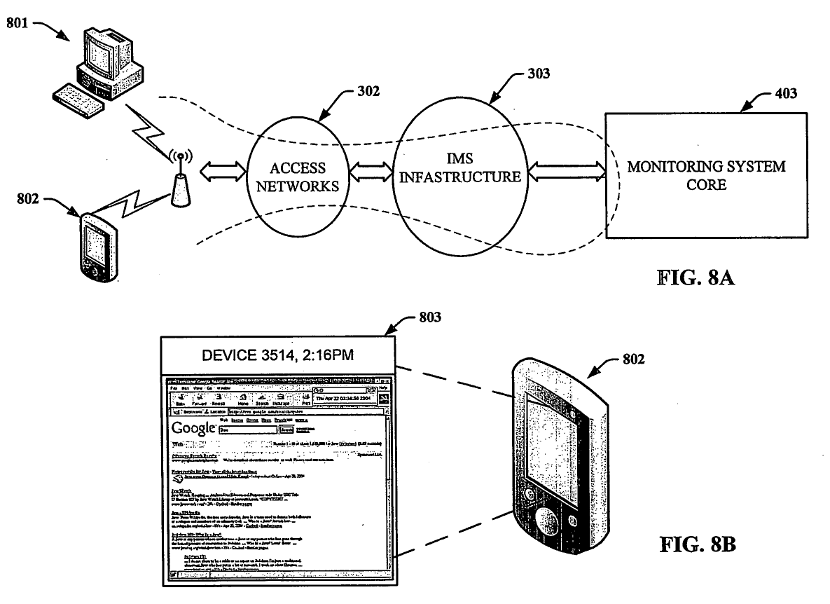

FIGS. 7 and 8 present examples of the process and product of the subject data usage monitoring and communicating system according to the methodology described in FIG. 6. FIG. 7A depicts two cellular phones both registered under one subscriber's network plan and joined as devices in a set. In FIG. 7A, cellular phone 1, 702, places a call to device 216-328-9353, 701 and cellular phone 2, 703 receives a data communication response according to the subscriber's plan. FIG. 7B depicts a possible display 704 of the usage data communication response within the display screen of cellular phone 2. FIG. 8A depicts a PC and a PDA both of which are registered under the subscriber's network plan and joined as devices in a set. In FIG. 8A, a user conducts a search on device 1, 801, while device 2, 802 receives a usage data communication response comprising the actual webpage search query displayed on the device 1. FIG. 8B depicts a possible display 803 of the data usage report within the display screen of the device 2. As depicted in FIG. 8B the display in on the receiving device is the actual web page generated and displayed on the PC. In another aspect of the invention, the communication response/web page can be made active so that the user of the PDA can further utilize the web page in the same functional manner as would the user of the PC.

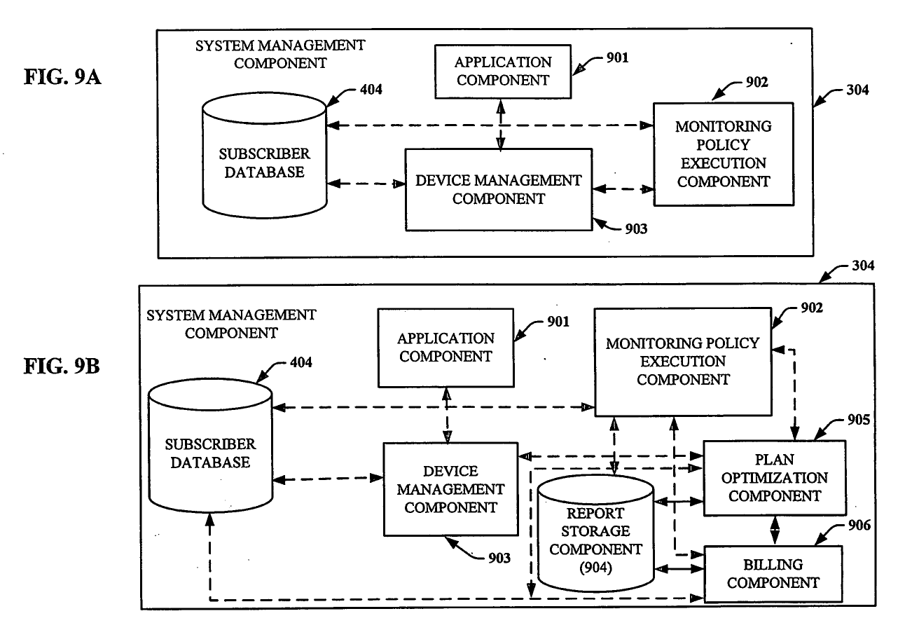

FIG. 9 two depicts different embodiments of the monitoring system core MSC 304 according to the subject invention. In reference to FIG. 9A, the MSC contains: a Device Management Component (DMC) 903, a Monitoring Policy Execution Component (MPEC) 902, a subscriber database SD 404, and an Application Component (AC) 901. Additional embodiments of the MSC 304 can compromise one or more of the above components in a variety of arrangements as well as any additional components that may be within the scope of the subjective system 400 in varying combinations thereof.

The DMC 903 is the main managing component of the system 400 of the subject invention. The DMC is in charge of defining monitoring policies, directing the MPEC 902 and interacting with the SD, AC and any additional components in the system architecture. The MPEC 902 is responsible for executing monitoring policy and compiling a data usage analysis for all activated devices subscribed to the network. The AC 901 is responsible for interpreting the data analysis report and distributing it in an appropriately formatted communication response.

FIG. 9B depicts another embodiment of the MSC 304 comprising all the components of FIG. 9A, with the addition of a report storage component 904, a billing component 906, and a plan optimization component 905. Each of the above mentioned components are further connected to the report component 1103 (not shown) of the MPEC.

The report storage component 904 acts as a reservoir for all generated usage data analysis reports created per device within the subject system 400. Alternatively, or in addition to sending a usage data report to the DMC 903, the MPEC 902 can send the report to the report storage component 904t. The stored report(s) can act as a back up log of every generated usage report. Therefore users can later retrieve usage data for a device(s) for a subscriber who elects the storage feature in their network plan. In another aspect of the invention, the subscriber can designate certain devices for which the usage data reports are stored. Given the report storage component, a user can retrieve the usage data from a device(s) continuously and/or in bulk at specific points throughout a specified time period. For example, a user could retrieve a search report conducted on a desktop PC on their PDA continuously or in bulk. Similarly, a user can elect to traverse through the log and receive a specific report for a specific device whenever they desire. Unlike existing management software, the stored report compiles real-time analysis of usage data from a heterogeneity of device's using a variety of access networks connected by a common network. Further, the report is accessible by a heterogeneity of devices in the form of a variety of communication responses.

The billing component 906 is responsible for comparing the data analysis report with the subscribers related billing requirements and producing an additional cost analysis related to the usage data. The ability to view a real-time billing analysis is beneficial for customers when making device usage decisions. For example, a subscriber can receive a billing analysis of specific service usage and decide to modify their service plan agreement or usage practices. Given the billing analysis in real-time, the subscriber is better able to remedy or optimize their usage habits and associated costs. In another example, for customers with limited monitoring plans, options not originally selected in their plan may be available for additional charge. The cost of utilizing a usage option outside of plan parameters would be established at the time of offering of the service and depend on the type and size of the service. For example, a device user can elect to receive an email log analysis, or be notified of the generation of an email log analysis. However, a user can also be notified that they have exceeded the maximum email log analysis reports for a particular device. In this case the user they can elect to receive a report instantaneously for additional charge. The billing component can encompass the entire system monitoring plan or as depicted in, a cellular service plan and any other service plans associated with the subscriber's devices. This component can further be tied to a plan optimizing component 906 to provide the subscriber notice of optional changes in plan parameters in order to maximize their usage capacity while reducing added costs.

The plan optimizing component 906 further analyzes the data analysis report in conjunction with the related charges and the subscribers plan in order to offer a possible modification in plan parameters that would better serve the subscribers usage needs in light of cost. In another aspect of the subject the plan optimizing component can analyze the type of usage and correlating programs and/or services associated with the usage in order to offer additional programs and services to the subscriber. The additional programs and/or services offered would have demonstrated a relation to those being utilized by the subscriber. Both the billing component 906 and the plan optimizing component 905 communicate with the SD 404 in order to extrapolate subscriber specific information related to billing and service plan agreements.

In yet another aspect, a plan optimizing component 906 is connected to the report storage component 906. The plan optimizing component can then extrapolate a segment of accumulated data analysis reports for one or more of the devices in the subscribers plan. The time period or size of the segment of data analysis, as well as the devices desired to be optimized, can be outlined by the subscriber's instructions contained in the SD 404. For example a subscriber can elect to have all of the data analysis reports generated by all thereof cellular phones connected in their cellular service family plan be analyzed by the plan optimizing component once a week. In this manner, the subscriber gains more control of the subscription accounts related to their devices, furthering satisfaction and compliance with their service providers.

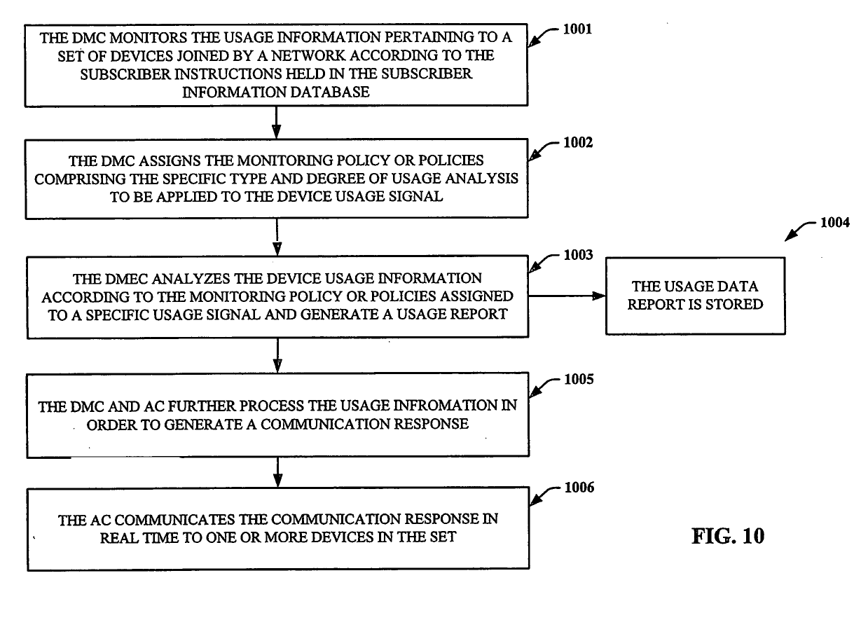

Referring back to the drawings, FIG. 10 presents a methodology by which real-time multi-device usage data monitoring and communicating is conducted according to the subject system within the MSC. At 1001 the DMC 903 monitors device usage information according to the subscriber instructions held in the SD 404. For example, the DMC can utilize information in the SD to know what devices to monitor and what usage data signals received from a certain device the DMC is instructed to assign a monitoring policy to. At 1002, the DMC assigns the monitoring policy or polices comprising the specific type and degree of usage analysis to be applied to a specific device usage signal. For example, once a usage signal is labeled as comprising usage data that is instructed to be monitored by the SD, the DMC further assigns a monitoring policy. In turn, the monitoring policy outlines the type of analysis to be conducted such as, search query analysis, email log analysis, call log analysis, etc. wherein one signal can comprise a monitoring policy with multiple types of data analysis. In addition to the type of data analysis, a monitoring policy can further include the degree of analysis. For example, within web page visiting analysis, the subscriber can vary the degree of analysis from reporting only the URL of the web page to reporting the amount of activity on the web page, or additionally the content and metadata associated with the web page.

Referring back to FIG. 10 at 1003 the usage data signal is analyzed according to the monitoring policy or policies it has been assigned in order to generate a usage data report. 1003 occurs within the MPEC. Following 1003, the usage data report can be stored, 1004, within the usage data storage component 904, and/or processed in order to generate a usage data communication response 1005. 1005 begins within the DMC and is completed within the AC 901. Finally at 1006, the communication response is communicated to any designated device within a joined set.

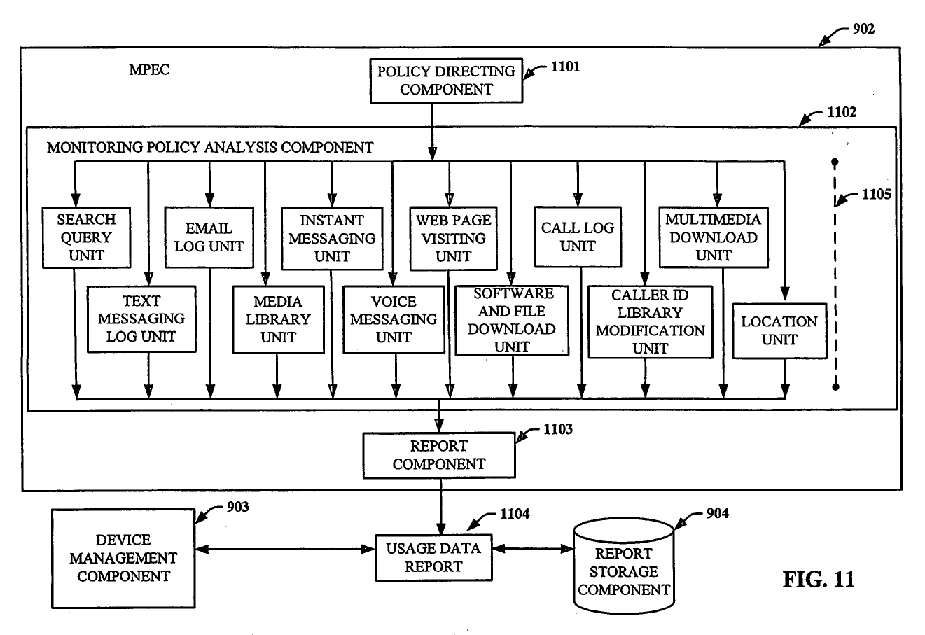

The MPEC will now be described in detail. FIGS. 11-13 present various embodiments of the MPEC. The MPEC, 902 as depicted in FIG. 11 includes a policy directing component 1101, a monitoring policy analysis component 1102, and a report component 1103. The monitoring policy analysis component is further made up of a plurality of policy analysis units 1105. When the MPEC receives a usage signal from the DMC, it is intercepted by the policy directing component. The policy directing component receives the usage data signal from the DMC with the appropriate usage data analysis to be carried as outlined by the monitoring policy or policies assigned to the signal. The policy directing component then differentiates between the multiple monitoring options available within the system and assigns the signal received from the DMC to the appropriate policy analysis unit 1105.

The monitoring policy analysis component 1102 is responsible for providing usage data analysis. The usage data analysis is conducted within a plurality of policy analysis units. In turn, each policy analysis unit is responsible for the analysis of a different data usage type. For example as depicted in FIG. 11, the policy analysis units include but are not limited to: a search query analysis, an email log analysis, an instant messaging analysis, a web page visiting analysis, a call log analysis, a multimedia download analysis, a media library analysis, a voice messaging analysis, a text messaging log analysis, a software and file download analysis, a caller ID library modification analysis, and a location analysis. It should be appreciated that each of the policy analysis units are capable of fully analyzing any and all data usage information which can be associated with its title including but not limited to: content, identities, type, quality, quantity, time, status, activity level, metadata, location, etc., as well as any data falling into or out of the above mentioned categories which falls within the scope of the subject invention.

Each policy analysis unit 1105 is responsible for analyzing the data message in varying degrees according to the subscriber's instructions. For example, the web page visiting log analysis can analyze the only the URL of the page visited or additionally, the time, duration, and metadata associated with the web page visit and the web page itself. On another note, the text messaging log analysis can include only the size and quantity of a text message or additionally, the receiving party, the duration of messaging, the time of messaging, and even the content of the message itself. As part of the analysis, each of the policy analysis units develops a usage data analysis summary or mini usage data report message (not shown). Each of the policy analysis units then sends their individual summaries to the report component 1103.

The report component 1103 is responsible for compiling the usage data analysis summaries from each policy analysis unit 1105 in order to generate one usage report 1104. The report is then relayed back to the DMC 903 which further interprets the report and channels the data to the AC 901. Additionally, in another aspect of the invention the report can be sent to a report storage component 904 for later retrieval or for additional analysis options, such as plan optimizing analysis as described above.

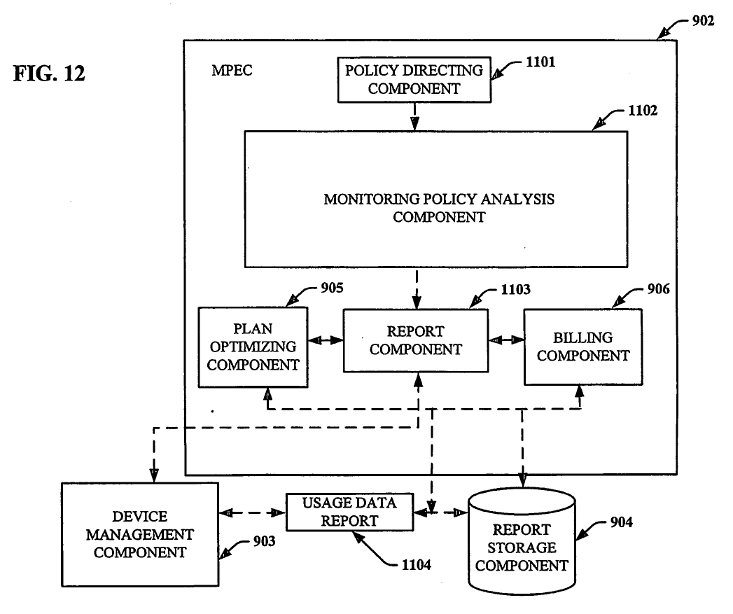

In another embodiment of the invention as depicted in FIG. 12, the MPEC further comprises a billing component 906 and a plan optimizing component 905 as described in detail above with reference to FIG. 9B. The billing component and the plan optimizing component each generate a usage report summary based on the compiled report data established in the report component or the storage component. The billing component and the plan optimizing component then send their individual summaries back to the report component which adds the additional information to the compiled usage data analysis unit summaries so that the billing an/or plan optimizing summary information can be included in the usage data report 1104.

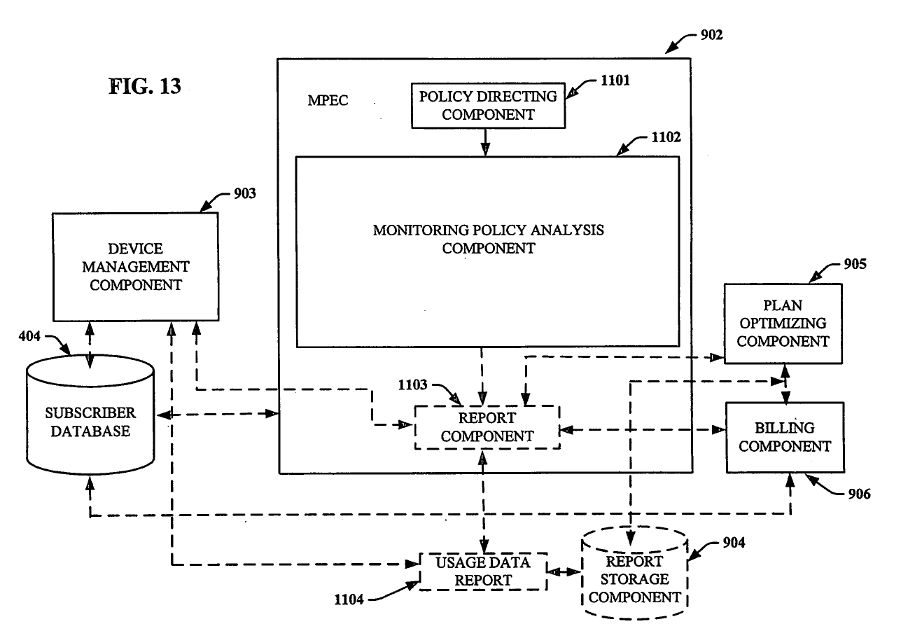

FIG. 13 illustrates another embodiment of the invention in which the billing component 906 and the plan optimizing component 905 are located outside of the MPEC yet within the MSC 304. This particular arrangement of the billing component and plan optimizing component is presented in FIG. 9B. The arrangement of the billing and plan optimizing components either outside or inside the MPEC does not change the function of either of the components. However, isolation of the billing component outside the MPEC renders the billing component independent of the MPEC. Given this arrangement, the billing component can serve functions related to a subscriber's service plan(s) that do not require involvement of real-time usage data analysis.

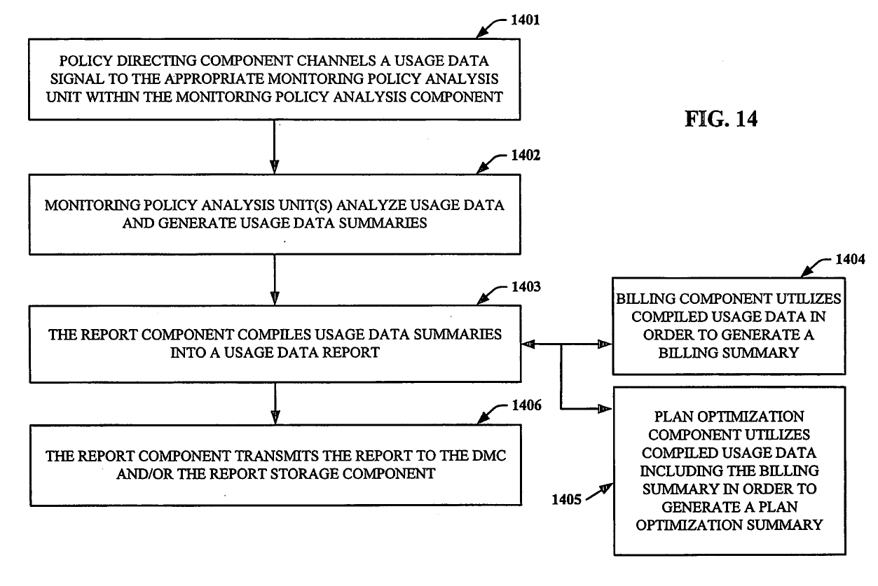

Referring back to the drawings, FIG. 14 presents a flow diagram demonstrating the method by which device usage data is processed through the MPEC in real-time according to an embodiment of the subject system wherein the billing component and plan optimization components are included. At 1401, the policy directing component channels a usage data signal to the appropriate monitoring policy analysis unit within the monitoring policy analysis component. At 1402, the monitoring policy analysis unit(s) then analyze the usage data signal in order to generate usage data summaries which are sent to the report component. At 1403, the report component then compiles the usage data summaries into a usage data report. The usage data report can then be extracted by the billing component at 1405 where the billing component utilizes the compiled usage data in order to generate a billing summary according to a service plan outlined in the SD 404. The billing summary is further sent back to the report component in order to be added into the usage data report. At 1405, the plan optimization component then uses compiled usage data, which includes the billing summary information, and generates a plan optimization summary. The plan optimization summary is further sent back to the report component in order to be added into the usage data report. Finally at 1406, the report component transmits the report to the DMC 903 and/or the report storage component 904.

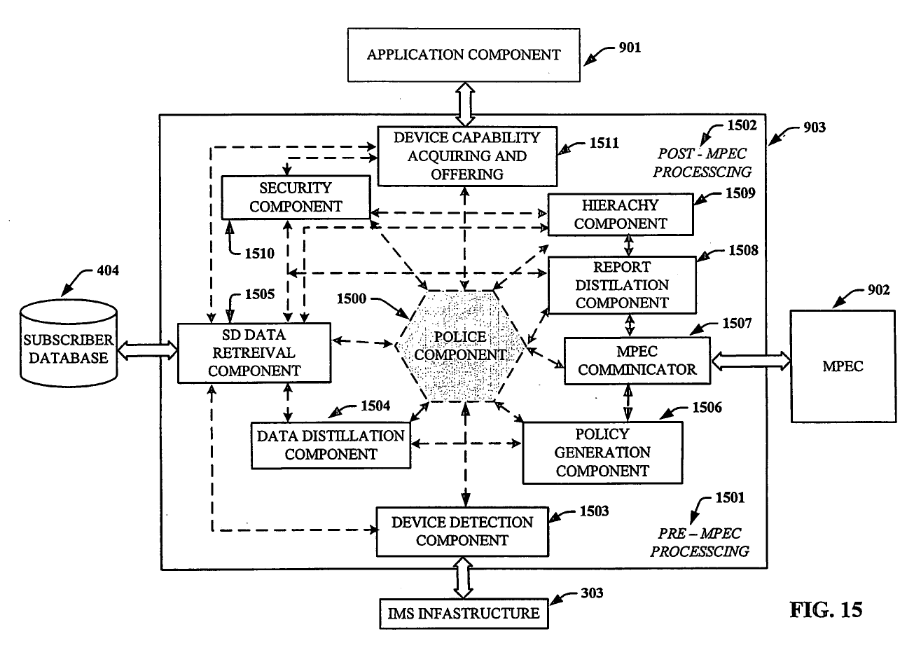

The device manager DMC 903 will now be described in detail. FIG. 15 illustrates a detailed a representation of the DMC 903. In an exemplary embodiment of the invention a network operator can designate a DMC for a group of various devices utilizing a heterogeneous array of access networks. One DMC can service multiple subscribers in a specified region. The DMC has multiple management roles and reciprocal components adapted to receive, process, and transmit device usage data signals between multiple devices.

In an exemplary embodiment of the invention, the components of the DMC 903 can be distinguished between two planes; a pre MPEC processing plane 1501 and a post MPEC processing plane 1502. However, some of the DMC components are shared between both planes including the police component 1500, the subscriber database SD data retrieval component 1505, and the MPEC communicator 1507.

The police component 1500 acts as the brain of the DMC 903. The police component organizes and delegates activity amongst the multiple components within the DMC. For example, the police component has the ability to examine a signal at any point throughout processing within the DMC and further direct the signal to the appropriate destination. All of the components within the DMC are connected to the police component. The SD data retrieval component 1505 is responsible retrieving subscriber information from the SD. Furthermore, the MPEC communicator 1507 is responsible for sending and receiving information between the MPEC and the DMC.

According to another aspect of the invention, in addition to the components shared between the pre MPEC and post MPEC processing planes, the pre MPEC processing plane includes but is not limited to: a device detection component 1503, a data distillation component 1504, and a policy generation component 1506. Additional embodiments of DMC can include one, none, or varying combinations of the above components. The device discovery component is responsible for receiving notice when a device connected to the system is in use. For example, the device discovery component will receive a signal from a PC connected to the system when a search is conducted. Additionally, the device discovery component will receive a signal when a cellular device connected to the system requests a specific usage data report stored in the report storage component.

The data distillation component 1504 is responsible for distilling the monitoring and communication information associated with a specific signal according to the subscriber's instructions held within the SD 404. For example, after a signal is received for a cellular phone making a call, the distillation process will utilize the information in the SD in order to pinpoint the particular monitoring and communication policies associated with the signal. The policy generation component 1506 is then responsible for assigning the associated monitoring policies to the signal. For example, while the distillation process identifies the monitoring and communication polices associated with signal, the policy generating process adapts the signal to include information containing the particular monitoring policies which will be carried out when the signal is received by the MPEC.

Referring back to FIG. 15, in addition to the components shared between the pre MPEC and post MPEC processing planes (e.g. the police component 1500, the SD data retrieval component 1505, and the MPEC communicator 1507), the post MPEC processing plane further includes but is not limited to: a report distillation component 1508, a hierarchy component 1509, a security component 1510, and a device capability acquiring and offering component 1511. The report distillation component separates and categorizes the usage data report according to the type of information reported and the possible corresponding display options. The display options can include a variety of multimedia display options or non multimedia display options. For example, information for a particular call made, such as minutes used and associated costs, could be categorized into either textual communication data or as graphical communication. Additionally, the data report can also indicate that the specific number associated with the usage data report is considered alarming. Thus the report distillation component would further categorize the data as reportable in audio display format where the subscriber elects to receive a sound alarm on a device when data is reported as alarming.

In another aspect of the invention, the report distillation component 1508 is connected to the SD data retrieval component 1505. Thus the report distillation component further has the capacity to utilize information contained in a SD to determine which aspects of the usage data report they have elected to receive a communication response from. For example although a subscriber may have elected to have several device usage aspects monitored, the subscriber can elect to have all of the usage aspects stored in the report storage unit while choosing to have only certain aspects delivered in a communication response format to another device in real-time.

Referring back to FIG. 15, the hierarchy component 1509 divides the order and degree in which various communication responses are delivered. For example a subscriber can elect to have data containing the actual content of an instant messaging communication be delivered to one device while the electing to have another device only receive notification of the associated billing costs of the communication. Similarly, the hierarchy component can determine the desired communication response format when the receiving device has the capability of receiving a variety of response formats. For example, a PC can receive a simple textual display, a graphical display, or a video display. The hierarchy component is further connected to the SD 404. When the hierarchy component receives a message for a device in which multiple communication format options are available, the component utilizes subscriber information in order to determine the priority response format for the particular message and receiving device. In another aspect of the invention, the hierarchy component can divide multiple data responses being sent to a single device into a priority order. For example, a subscriber can elect to receive an alarm response before a textual response, and vice versa.

Referring back to FIG. 15, the security component 1510 is responsible for controlling subscriber security of every signal that is processed by the system before it leaves the system. The security component is also connected to the SD 404 by way of the SD data retrieval component. The security component uses subscriber information in order to determine which devices are allowed to receive a data usage report or response. Although other components within the system rely on subscriber information in order to produce a communication response tailored to a specific device within a set, the security component acts as the final check on any message leaving the system in order to ensure subscriber security of device usage information. Therefore, if a device user were to request a specific data usage report that was not delegated within the subscriber's plan, the security component would not allow a communication response comprising usage data information to be sent out.

Referring back to FIG. 15, the device capability acquiring and offering component 1511 additionally utilizes subscriber information in order to determine the capabilities of receiving device(s). For example, certain devices can be equipped to receive video and sound communication responses while others only textual responses. The device capability acquiring and offering component is also connected to the SD via the SD data retrieval component 1505. A determination of receiving device capabilities allows for the device capability acquiring and offering component to send the message to the AC 901 with the appropriate receiving device formatting instructions.

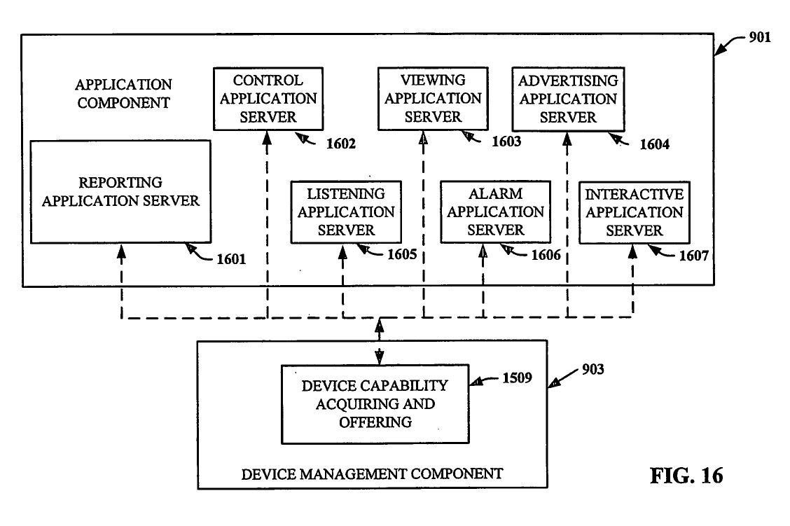

The application component AC 901 will now be described in detail. FIG. 16 presents the AC in an embodiment of the subject system. Within the AC, a variety of application servers 1601-1607 can be employed for fulfilling multiple communication responses. Alternatively or in addition, one application server can have the capability of offering multiple communication responses. The application servers are responsible for applying a usage data signal in accordance with the receiving device capabilities in order to generate an appropriately formatted communication response. Therefore each AS, regardless of communication application, has the ability to process a wide range of multimedia and non-multimedia responses. For example, the advertising application server can process usage data and generate textual advertisements, pictorial advertisements, audio advertisements, etc. The AC further communicates the communication response to the receiving device.

Referring back to the drawings, FIG. 16 presents a variety of possible application servers: a reporting application server 1601, a control application server 1602, a viewing application server 1603, an advertising application server 1604, a listening application server 1605, an alarm application server 1606, and an interactive application server 1607. It should be appreciated that additional applications and their reciprocal application servers may exist or arise that are within the scope of the invention. Thus the subject invention is not limited to the above mentioned applications.

The reporting application server 1601 is responsible for sending a communication response encompassing all forms of display or interactive messaging for usage data information. For example, the usage data report can be a text message, a web page search display, a video message, etc. The control application 1602 allows users with responsive capabilities on their devices to interactively respond to a communication response. For example, in response to a usage data communication response, a receiving device may elect to remotely manipulate the functionality of another device within a joined set. In a similar manner, the viewing application 1603 and the listening application 1604 may allow a user to respond to a usage data report and elect to listen in on a phone conversation or concurrently view an accessed video webcast on another device.

Furthermore, the interactive application 1607 can allow for transmittal of usage data between devices. For example a user can produce a usage data report from an action conducted on one device and have the usage data information transferred to a secondary device. The secondary device can then be enabled with a program to automatically respond to the usage data information and transmit an additional communicating response back to the first device. Such interaction can be carried out for an indefinite amount of time or be limited by the subscriber's network monitoring plan. Communication in this manner enables devices with limited computing, software, or multimedia capabilities to share or exploit the more complex capabilities of another device.

Referring back to FIG. 16, the alarm application 1606 is responsible for sending an alarming communication response. The alarm communication response can be a sound, a text, a video, a vibration, or any other appropriately formatted response. A subscriber can designate a specific type of usage data to be tagged as “alarming” and consequentially cause an associated alarm communication response within a receiving device(s). The alarm application can be differentiated as its own application server (as it is depicted in FIG. 14) or it can be included within the reporting application server. Finally, the advertising application 1604 can serve the function of receiving usage data report information and offering instantaneous advertisements to users based on the information. For example, usage data can be generated from a portable PC device under the user's plan indicating a search for pizza establishments. The advertising component can utilizes this information to automatically send advertisements from participating pizza establishments to a secondary device utilized by the subscriber.

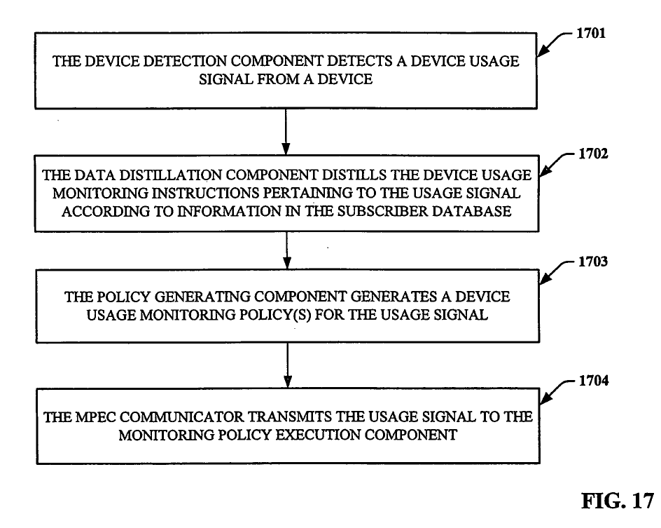

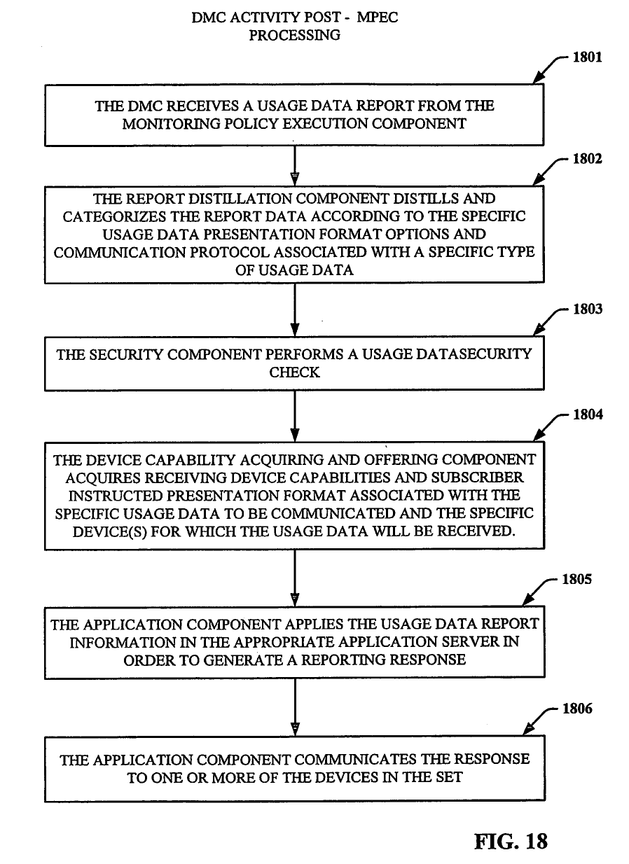

Referring back to the drawings, FIGS. 17 and 18, depict the methodology by which a signal transmitted from a device is received and processed within the DMC 903. FIG. 17. presents DMC activity pre MPEC processing and FIG. 18. presents DMC activity post MPEC processing without reference to the processing through the hierarchy component 1509. FIG. 18 further includes the methodology by which a post MPEC processed message is served by the application servers. In FIG. 17, at 1701, the device detection component 1503 detects a device usage signal from a device. At 1702, the data distillation component 1504 distills the device usage data monitoring instructions pertaining to the usage data signal according to information in the SD. At 1703, the policy generating component 1506 generates a device usage monitoring policy for the usage signal. At 1704, the MPEC communicator 1507 transmits the usage signal to the MPEC.

In FIG. 18, at 1801 the DMC 903 receives a usage data report from the MPEC by way of the MPEC communicator 1507. At 1802 the report distillation component 1508 distills and categorizes the report data according to the specific usage data presentation format options and communication protocol associated with a specific type of usage data. At 1803 the security component 1510 performs a usage data security check. At 1804, the device capability acquiring and offering component 1511 acquires the receiving device capabilities and subscriber instructed presentation format associated with the specific usage data to be communicated and the device(s) for which the usage data will be received. At 1805 the AC 901 applies the usage data report information in the appropriate application server 1601-1607 in order to generate a reporting response. Finally, at 1806, the AC communicates the response to one or more of the devices in the set.

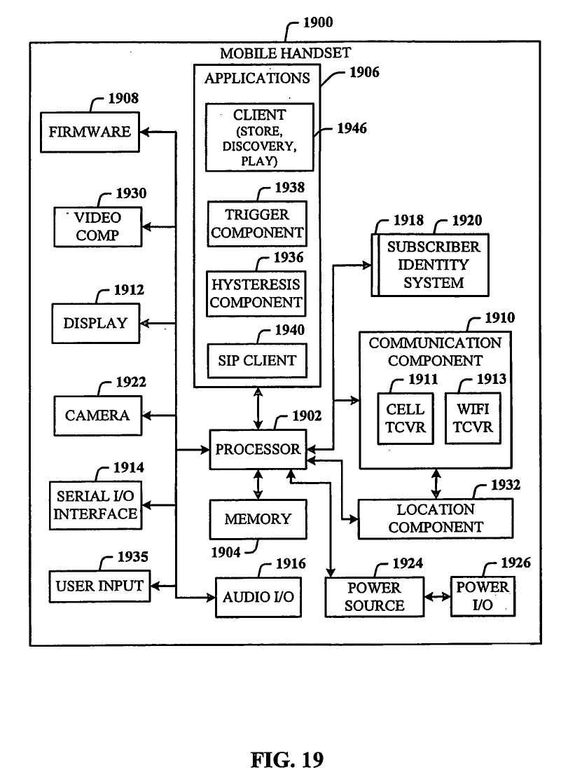

FIG. 19 illustrates a schematic block diagram of an exemplary device 1900 capable of employing the subject system in accordance with some embodiments of the invention. The device is a mobile handset 1900 In order to provide additional context for various aspects thereof, FIG. 19 and the following discussion are intended to provide a brief, general description of a suitable environment 1900 in which the various aspects can be implemented. While the description includes a general context of computer-executable instructions, those skilled in the art will recognize that the innovation also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the inventive methods can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of computer-readable media. Computer-readable media can be any available media that can be accessed by the computer and includes both volatile and non-volatile media, removable and non-removable media. By way of example and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media can include, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 1900 includes a processor 1902 for controlling and processing all onboard operations and functions. A memory 1904 interfaces to the processor 1902 for storage of data and one or more applications 1906 (e.g., a video player software, user feedback component software, . . . ). Other applications can include voice recognition of predetermined voice commands that facilitate initiation of the user feedback signals. The applications 1906 can be stored in the memory 1904 and/or in a firmware 1908, and executed by the processor 1902 from either or both the memory 1904 or/and the firmware 1908. The firmware 1908 can also store startup code for execution in initializing the handset 1900. A communications component 1910 interfaces to the processor 1902 to facilitate wired/wireless communication with external systems, e.g., cellular networks, VoIP networks, and so on. Here, the communications component 1910 can also include a suitable cellular transceiver 1911 (e.g., a GSM transceiver) and an unlicensed transceiver 1913 (e.g., WiFi, WiMax) for corresponding signal communications. The handset 1900 can be a device such as a cellular telephone, a PDA with mobile communications capabilities, and messaging-centric devices. The communications component 1910 also facilitates communications reception from terrestrial radio networks (e.g., broadcast), digital satellite radio networks, and Internet-based radio services networks.

The handset 1900 includes a display 1912 for displaying text, images, video, telephony functions (e.g., a Caller ID function), setup functions, and for user input. The display 1912 can also accommodate the presentation of multimedia content (e.g., music metadata, messages, wallpaper, graphics . . . ). A serial I/O interface 1914 is provided in communication with the processor 1902 to facilitate wired and/or wireless serial communications (e.g., USB, and/or IEEE 1394) through a hardwire connection, and other serial input devices (e.g., a keyboard, keypad, and mouse). This supports updating and troubleshooting the handset 1900, for example. Audio capabilities are provided with an audio I/O component 1916, which can include a speaker for the output of audio signals related to, for example, indication that the user pressed the proper key or key combination to initiate the user feedback signal. The audio I/O component 1916 also facilitates the input of audio signals through a microphone to record data and/or telephony voice data, and for inputting voice signals for telephone conversations.

The handset 1900 can include a slot interface 1918 for accommodating a SIC (Subscriber Identity Component) in the form factor of a card Subscriber Identity Module (SIM) or universal SIM 1920, and interfacing the SIM card 1920 with the processor 1902. However, it is to be appreciated that the SIM card 920 can be manufactured into the handset 1900, and updated by downloading data and software thereinto.

The handset 1900 can process IP data traffic through the communication component 1910 to accommodate IP traffic from an IP network such as, for example, the Internet, a corporate intranet, a home network, a person area network, etc., through an ISP or broadband cable provider. Thus, VoIP traffic can be utilized by the handset 1900 and IP-based multimedia content can be received in either an encoded or decoded format.

A video processing component 1922 (e.g., a camera) can be provided for decoding encoded multimedia content. The handset 1900 also includes a power source 1924 in the form of batteries and/or an AC power subsystem, which power source 1924 can interface to an external power system or charging equipment (not shown) by a power I/O component 1926.

The handset 1900 can also include a video component 1930 for processing video content received and, for recording and transmitting video content. A location tracking component 932 facilitates geographically locating the handset 1900. As described hereinabove, this can occur when the user initiates the feedback signal automatically or manually. A user input component 1934 facilitates the user initiating the quality feedback signal. The input component can include such conventional input device technologies such as a keypad, keyboard, mouse, stylus pen, and touch screen, for example.

Referring again to the applications 1906, a hysteresis component 1936 facilitates the analysis and processing of hysteresis data, which is utilized to determine when to associate with the access point. A software trigger component 1938 can be provided that facilitates triggering of the hysteresis component 1938 when the WiFi transceiver 1913 detects the beacon of the access point. A SIP client 940 enables the handset 1900 to support SIP protocols and register the subscriber with the SIP registrar server. The applications 1906 can also include a client 1942 that provides at least the capability of discovery, play and store of multimedia content, for example, music.

The handset 1900, as indicated above related to the communications component 910, includes an indoor network radio transceiver 1913 (e.g., WiFi transceiver). This function supports the indoor radio link, such as IEEE 802.11, for the dual-mode GSM handset 1900. The handset 1900 can accommodate at least satellite radio services through a handset that can combine wireless voice and digital radio chipsets into a single handheld device.

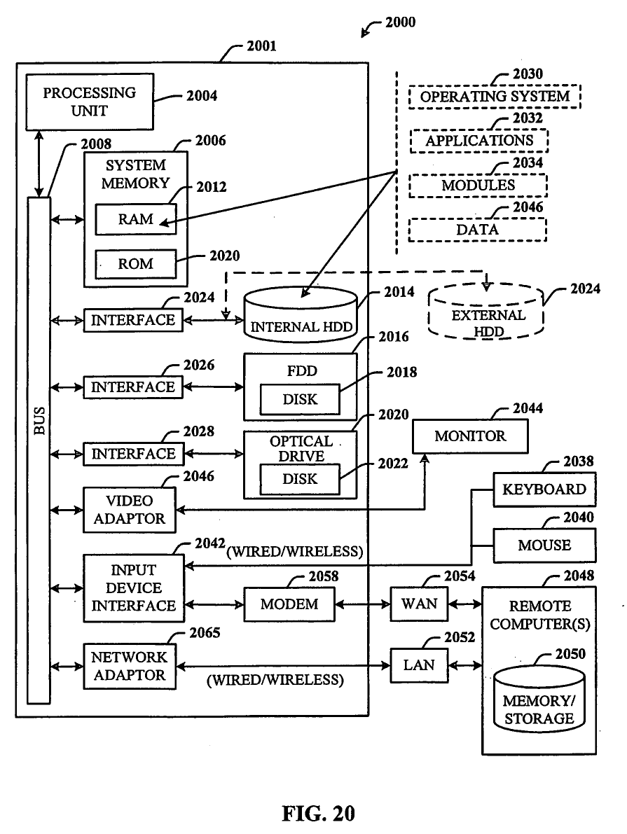

Referring now to FIG. 20, there is illustrated a block diagram of a computer operable to provide networking and communication capabilities between a wired or wireless communication network and a server and/or communication device. In order to provide additional context for various aspects thereof, FIG. 20 and the following discussion are intended to provide a brief, general description of a suitable computing environment 1000 in which the various aspects of the innovation can be implemented. While the description above is in the general context of computer-executable instructions that can run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 20, the exemplary environment 2000 for implementing various aspects includes a computer 2002, the computer 2002 including a processing unit 2004, a system memory 2006 and a system bus 2008. The system bus 2008 couples system components including, but not limited to, the system memory 2006 to the processing unit 2004. The processing unit 2004 can be any of various commercially available processors. Dual microprocessors and other multi-processor architectures can also be employed as the processing unit 2004.

The system bus 2008 can be any of several types of bus structure that can further interconnect to a memory bus (with or without a memory controller), a peripheral bus, and a local bus using any of a variety of commercially available bus architectures. The system memory 2006 includes read-only memory (ROM) 2010 and random access memory (RAM) 2012. A basic input/output system (BIOS) is stored in a non-volatile memory 2010 such as ROM, EPROM, EEPROM, which BIOS contains the basic routines that help to transfer information between elements within the computer 2002, such as during start-up. The RAM 2012 can also include a high-speed RAM such as static RAM for caching data.

The computer 2002 further includes an internal hard disk drive (HDD) 2014 (e.g., EIDE, SATA), which internal hard disk drive 2014 can also be configured for external use in a suitable chassis (not shown), a magnetic floppy disk drive (FDD) 2016, (e.g., to read from or write to a removable diskette 2018) and an optical disk drive 2020, (e.g., reading a CD-ROM disk 1022 or, to read from or write to other high capacity optical media such as the DVD). The hard disk drive 2014, magnetic disk drive 2016 and optical disk drive 2020 can be connected to the system bus 2008 by a hard disk drive interface 2024, a magnetic disk drive interface 2026 and an optical drive interface 2028, respectively. The interface 2024 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 2002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing the methods of the disclosed innovation.

A number of program modules can be stored in the drives and RAM 2012, including an operating system 2030, one or more application programs 2032, other program modules 2034 and program data 2036. All or portions of the operating system, applications, modules, and/or data can also be cached in the RAM 2012. It is to be appreciated that the innovation can be implemented with various commercially available operating systems or combinations of operating systems.

A user can enter commands and information into the computer 2002 through one or more wired/wireless input devices, e.g., a keyboard 2038 and a pointing device, such as a mouse 2040. Other input devices (not shown) may include a microphone, an IR remote control, a joystick, a game pad, a stylus pen, touch screen, or the like. These and other input devices are often connected to the processing unit 2004 through an input device interface 2042 that is coupled to the system bus 2008, but can be connected by other interfaces, such as a parallel port, an IEEE 2394 serial port, a game port, a USB port, an IR interface, etc.

A monitor 2044 or other type of display device is also connected to the system bus 2008 through an interface, such as a video adapter 2046. In addition to the monitor 2044, a computer typically includes other peripheral output devices (not shown), such as speakers, printers, etc.

The computer 2002 can operate in a networked environment using logical connections by wired and/or wireless communications to one or more remote computers, such as a remote computer(s) 2048. The remote computer(s) 2048 can be a workstation, a server computer, a router, a personal computer, portable computer, microprocessor-based entertainment appliance, a peer device or other common network node, and typically includes many or all of the elements described relative to the computer 2002, although, for purposes of brevity, only a memory/storage device 2050 is illustrated. The logical connections depicted include wired/wireless connectivity to a local area network (LAN) 2052 and/or larger networks, e.g., a wide area network (WAN) 2054. Such LAN and WAN networking environments are commonplace in offices and companies, and facilitate enterprise-wide computer networks, such as intranets, all of which may connect to a global communications network, e.g., the Internet.

When used in a LAN networking environment, the computer 2002 is connected to the local network 2052 through a wired and/or wireless communication network interface or adapter 2056. The adaptor 2056 may facilitate wired or wireless communication to the LAN 2052, which may also include a wireless access point disposed thereon for communicating with the wireless adaptor 2056.

When used in a WAN networking environment, the computer 2002 can include a modem 2058, or is connected to a communications server on the WAN 2054, or has other means for establishing communications over the WAN 2054, such as by way of the Internet. The modem 2058, which can be internal or external and a wired or wireless device, is connected to the system bus 2008 through the serial port interface 2042. In a networked environment, program modules depicted relative to the computer 2002, or portions thereof, can be stored in the remote memory/storage device 2050. It will be appreciated that the network connections shown are exemplary and other means of establishing a communications link between the computers can be used.

The computer 2002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least WiFi and Bluetooth™ wireless technologies. Thus, the communication can be a predefined structure as with a conventional network or simply an ad hoc communication between at least two devices.

WiFi, or Wireless Fidelity, allows connection to the Internet from a couch at home, a bed in a hotel room, or a conference room at work, without wires. WiFi is a wireless technology similar to that used in a cell phone that enables such devices, e.g., computers, to send and receive data indoors and out; anywhere within the range of a base station. WiFi networks use radio technologies called IEEE 802.11 (a, b, g, etc.) to provide secure, reliable, fast wireless connectivity. A WiFi network can be used to connect computers to each other, to the Internet, and to wired networks (which use IEEE 802.3 or Ethernet). WiFi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for monitoring device specific usage information of a set of N numbered devices joined by a common network, where N is an integer, comprising;
a subscriber information database that stores instructions governing devices of the set; and,
a system management component that monitors and analyzes usage information generated by a subset of the set of devices, and in response to a request provides in real-time a response regarding the usage information regarding the subset of devices.

2. The system of claim 1, wherein the common network joining the devices is an IP Multimedia Subsystem.

3. The system of claim 1 wherein the instructions, comprise at least one of:
recording all of the devices included in the set and their reciprocal functionalities and capabilities;
detailing usage information monitoring policies, the policies including specific type and degree of usage data analysis to be applied to a specific device usage signal, specifications regarding processing or storing of the usage data, and the usage data communication protocol;
detailing preferences and features associated with the monitoring policies; or
outlining device service plan agreement parameters and associated billing information.

4. The system of claim 1 wherein the response comprises one or more of the following responses: a report encompassing an analysis of device usage information as instructed by the subscriber, an advertisement based on device usage information, an option to remotely control the functions and applications of another device in the set, an option to interact with another device in the set, an option to view multimedia in use on another device, an option to listen to audio transmissions from another device in the set, or an option to receive an alarm.

5. The system of claim 3 wherein the system management component further assigns the monitoring policy or polices associated with a device usage information signal, analyzes the device usage information according to the monitoring policy or polices assigned to a specific usage signal in order to generate a usage data report which aggregates all the analyzed usage data in a single body, and at least one of:
stores the usage data report in a form allowing for on demand access of device usage information; or
processes the usage data report according to the monitoring policy or policies assigned to the specific usage data signal in order to generate a specific response to the monitored usage data, and communicates the response to any of the devices within the set in real-time.

6. The system of claim 3 further comprises:
a monitoring policy execution component that analyzes the device usage information according to the monitoring policy or policies associated with a specific device usage information signal and generates a usage data report which aggregates the analyzed usage data in a single body.

7. The system of claim 6 further comprises a policy directing component that channels a usage data signal to one or more respective monitoring policy analysis units, the units conduct analysis of a specific type of usage data.

8. The system of claim 6 comprising a report component that generates a report regarding the aggregated analyzed usage data.

9. The system of claim 3 wherein the type of usage data analysis comprises at least one of: search query analysis, email log analysis, instant messaging analysis, web page visiting analysis, call log analysis, multimedia download analysis, media library analysis, voice messaging analysis, text messaging analysis, software and file download analysis, caller ID library modification analysis, or location analysis.

10. The system of claim 1 further comprising a billing component which
retrieves charging information related to device usage from the device service plan agreement information located in the subscriber database, and
generates a billing analysis associated with the monitored device usage information.

11. The system of claim 10 further comprising a plan optimizing component which utilizes the billing analysis associated with monitored device usage information and,
compares the usage information and related billing information to the subscriber service plan agreement parameters held in the subscriber database, and
generates an analysis establishing a proposed modification in service plan parameters that optimizes user preferences, or offers optimized economic plan parameters.

12. The system of claim 3 wherein the system management component further comprises a device management component that detects a device usage signal from the device(s) in the set, distills the device usage monitoring instructions pertaining to a specific usage signal and, generates a device usage monitoring policy for the usage signal.

13. The system of claim 6 wherein the system management component further comprises a device management component that distills and categorizes the usage data report according to specific usage data presentation format options and communication protocol associated with a specific type of usage data.

14. The system of claim 13, the device management component acquires receiving device capabilities and the subscriber instructed presentation format associated with the specific usage data to be communicated and the specific device(s) for which the usage data and will be received, and transmits the formatted usage data.

15. The system of claim 13 wherein the device management component further comprises a component for policing activity of the device management component.

16. The system of claim 13 wherein the device management component further comprises a component that controls order and degree in which various communication responses are communicated.

17. They system of claim 13 wherein the device management component further comprises a component that ensures security of device usage data being released by the system.

18. They system of claim 1 wherein the system management component further comprises an application component which applies device usage information in a manner that generates a response to the monitored usage data and communicates the response to one or more of the devices in the set.

19. The system of claim 18 wherein the communication responses are presented in a manner which allows for receiving device(s) to view the usage data information response in the form of one or more of the following multimedia formats or combinations thereof including: text, audio, still images, animation, video, and interactivity content forms,
respond to the usage data communication response by interacting with one or more of the devices in the set, and
exploit the usage data information in a same functional capacity as the originating device.

20. The system of claim 1 wherein the set of devices includes any device capable of communicating in at least one format or using at least one protocol that is recognized by the system management component.

21. The system of claim 20 wherein the set of devices further includes both wireless and wireline devices utilizing a variety of access networks.

22. A method for monitoring device specific usage information of a set of N numbered devices joined by a common network, where N is an integer, comprising;
monitoring device usage information according to instructions stored in a subscriber information which governs the devices of the set,
analyzing the usage information according to the instructions and at least one of:
processing the analyzed data in order to generate a response and communicating the response to any of the devices within the set in real-time, or
storing the analyzed usage information.

23. The method of claim 22 wherein the communicated response includes one or more of: a report encompassing an analysis of device usage information as instructed by the subscriber, an advertisement based on device usage information, an option to remotely control the functions and applications of another device in the set, an option to interact with another device in the set, an option to view multimedia in use on another device, an option to listen to audio transmissions from another device in the set, and an option to receive an alarm.

24. The method of claim 22 further comprising;
assigning a monitoring policy associated with a device usage information signal, said monitoring policy or polices being held within the subscriber information database and
analyzing the device usage information according to the monitoring policy in order to generate a usage data report which aggregates the analyzed usage data in a single body, and at least one of:
storing the usage data report in a form allowing for on demand access of device usage information or
processing the usage data report according to the assigned monitoring policy in order to generate a response and communicating the response to any of the devices within the set in real-time.

25. The method of claim 22 wherein the type of usage data monitored includes the content, identity, type, quality, quantity, time, status, activity level, and metadata associated with search query data, email log data, instant messaging data, web page visiting data, call log data, multimedia download data, media library data, voice messaging data, text messaging data, software and file download data, caller ID library modification data.

26. The method of claim 22 wherein a billing component
retrieves charging information related to device usage from the device service plan agreement information located in the subscriber database, and
generates a billing analysis associated with the monitored device usage information.

27. The method of claim 26 wherein a plan optimizing component utilizes the billing analysis associated with monitored device usage information and
compares the usage information and related billing information to the subscriber service plan agreement parameters held in the subscriber database, and
generates an analysis establishing a proposed modification in service plan parameters that optimizes user preferences and/or offers more economical plan parameters.

28. The method of claim 22 further comprising;
detecting device usage signal from the device(s) in the set
distilling the device usage monitoring instructions pertaining to a specific usage signal and,
generating a device usage monitoring policy or polices for the usage signal.

29. The method of claim 28 further comprising
transmitting a usage data signal and its associated monitoring policy or policies to a monitoring policy execution component wherein usage information is analyzed and compiled into a usage data report, said report aggregating the analyzed usage data in a single body, and
receiving the usage data report from the monitoring policy execution component.

30. The method of claim 29 further comprising
distilling and categorizing the usage data report information according to the specific usage data presentation format options and communication protocol associated with a specific type of usage data,
acquiring receiving device capabilities and the subscriber instructed presentation format associated with the specific usage data to be communicated and the specific device(s) for which the usage data and will be received, and
transmitting the formatted usage data to a component wherein a communication response is generated.

31. The method of claim 22 wherein the order and degree in which various communication responses are communicated to a receiving device is controlled.

32. The method of claim 22 wherein the security of all device usage data being released by the system is ensured.

33. The method of claim 22 wherein the communication response is presented in a manner which allows for the receiving device(s) to
view the usage data information response a format including one or more of: text, audio, still images, animation, video, or interactive content formats,
respond to the communication response by interacting with one or more of the devices in the set in and,
exploit the usage data information in the same functional capacity as the originating device.

34. A means for monitoring device specific usage information of a set of N numbered devices joined by a common network, where N is an integer, comprising;
a subscriber information database that stores instructions governing devices of the set; and,
a system management component that monitors and analyzes usage information generated by a subset of the set of devices, and in response to a request provides in real-time a response regarding the usage information regarding the subset of devices.
